(19) United States
(12) Patent Application Publication
(10) Pub. No.: US 2014/0380233 A1
(43) Pub. Date: Dec. 25, 2014

(54) User Interface With Sliding Cursor for Multimodal Communication Framework

(71) Applicant: Zeta Project Swiss GmbH, Zug (CH)

(72) Inventors: Priidu Zilmer, Tallinn (EE); Angel Sergio Palomo Pascual, Helsinki (FI); Oliver Reitalu, Tallinn (EE); Jaanus Kase, Tallinn (EE)

(21) Appl. No.: 14/309,321

(22) Filed: Jun. 19, 2014

Related U.S. Application Data
(60) Provisional application No. 61/838,841, filed on Jun. 24, 2013.
(60) Provisional application No. 61/838,942, filed on Jun. 25, 2013.

(51) Int. Cl. G06F 3/0484; G06F 3/0488; G06F 3/0481

(52) U.S. Cl. CPC G06F 3/04847; G06F 3/04817; G06F 3/0488
USPC 715/781

(57) ABSTRACT

A graphical user interface (GUI) for a device operable in a unified communication framework in which multiple users communicate using multiple modes. Conversations are kept consistent across users' devices. The GUI makes efficient use of a display, providing GUI options and menus that are exposed by sliding a cursor.

### RELATED APPLICATIONS

This application is related to and claims priority from co-pending and co-owned (i) U.S. provisional patent application No. 61/838,841, filed Jun. 24, 2013; and (ii) U.S. provisional patent application No. 61/838,942, filed Jun. 25, 2013, the entire contents of each of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

1. Field of the Invention

This invention relates to a communication framework, and, more particularly, to a graphical user interface for a communication framework.

2. Background and Overview

Computers and computing devices, including so-called smartphones, are ubiquitous, and much of today's communication takes place via such devices. In many parts of the world, computer-based inter-party communication has superseded POTS systems.

Various messaging systems such as, e.g., Skype, Apple's messaging system and the like, provide graphical user interfaces (GUIs) to their systems. However, the GUI's of many of these systems make very inefficient use of the screen area. The graphical user interface of a typical messaging system includes multiple icons or active regions corresponding to possible user options. However, such a use of a screen is inefficient in many modes of operation.

It is desirable to provide a user interface that makes efficient use of the display area a devices' screen in multiple modes of operation and across multiple types of devices.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 shows an overview of an exemplary communication framework in accordance with an embodiment;

FIGS. 2(A)-2(D) depict aspects of exemplary devices for use in a system in accordance with an embodiment;

FIG. 3(A) depicts an exemplary user interface (UI) according to embodiments hereof;

FIGS. 3(B)-3(F) depict aspects of input regions of exemplary UIs in a communication framework such as that shown in FIG. 1;

FIG. 4 depicts a menu hierarchy in an exemplary UI in a communication framework;

FIGS. 5(A)-5(E), 6(A)-6(E), 7(A)-7(F) depict aspects of a user interface in accordance with embodiments hereof;

FIGS. 8-9 depict menu hierarchies in an exemplary UI in a communication framework;

FIGS. 10(A)-10(E) depict aspects of a user interface in accordance with embodiments hereof;

FIG. 11 depicts a menu hierarchy in an exemplary UI in a communication framework;

FIGS. 12(A)-12(E), 13(A)-13(F), and 14(A)-14(D) depict aspects of a user interface in accordance with embodiments hereof;

FIGS. 15(A)-15(E) are screen shots of exemplary implementations in accordance with embodiments hereof;

FIGS. 15(F)-15(G) depict menu hierarchies of the exemplary UIs of FIGS. 15(B) and 15(D), respectively; and

FIGS. 16(A)-16(C) depict aspects of computing and computer devices in accordance with embodiments hereof.

### DETAILED DESCRIPTION OF THE PRESENTLY PREFERRED EXEMPLARY EMBODIMENTS GLOSSARY AND ABBREVIATIONS

As used herein, unless used otherwise, the following terms or abbreviations have the following meanings:

API means application programming interface;

GUI means graphical user interface (UI);

UI means user interface;

URI means Uniform Resource Identifier:

URL means Uniform Resource Locator;

VKB means virtual keyboard.

As used herein, the term “mechanism” refers to any device(s), process(es), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### BACKGROUND AND OVERVIEW

### Overview—Structure

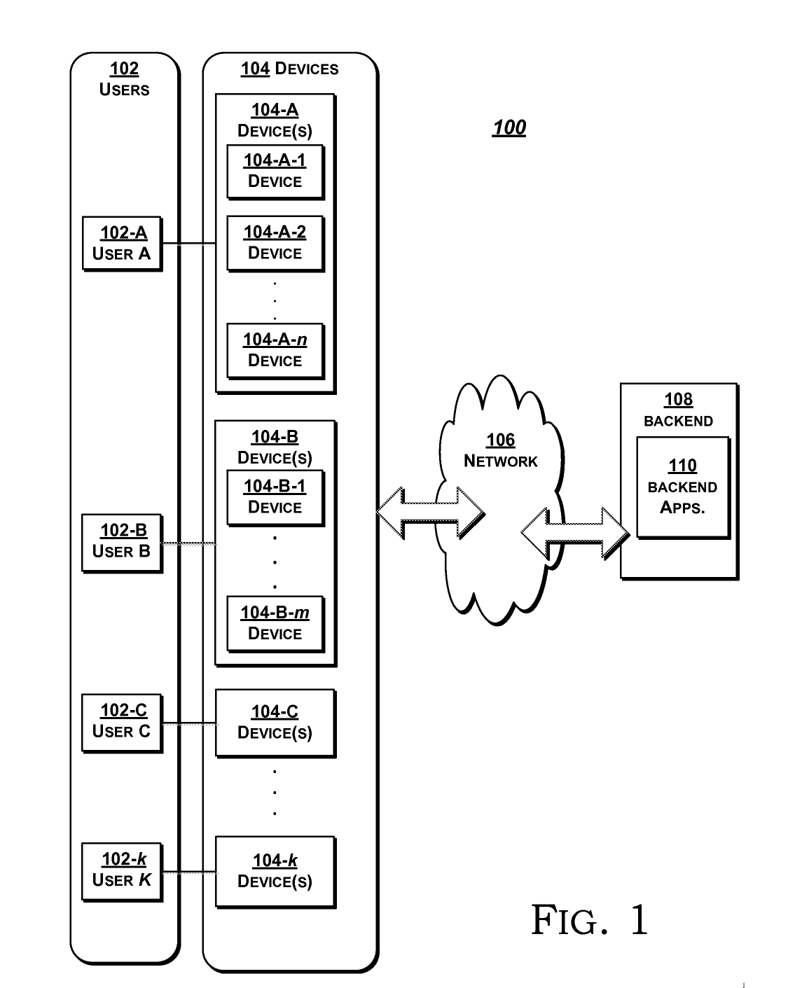

FIG. 1 shows an overview of an exemplary framework 100 for a communications system. Within the framework 100, a user 102 may have one or more devices 104 associated therewith. For example, as shown in FIG. 1, user 102-A has device(s) 104-A (comprising devices 104-A-1, 104-A-2 . . . 104-A-n) associated therewith. Similarly, user 102-B has device(s) 104-B (comprising devices 104-B-1 . . . 104-B-m) associated therewith. The association between the user and the devices is depicted in the drawing by a line connecting a user 102 with device(s) 104 associated with that user. Although only four user/device associations are shown in the drawing, it should be appreciated that a particular system may have an arbitrary number of users, each with an arbitrary number of devices.

It should be appreciated that a user 102 may not correspond to a person or human, and that a user 102 may be any entity (e.g., a person, a corporation, a school, etc.).

Users 102 may use their associated device(s) 104 to communicate with each other within the framework 100. A user's device(s) may communicate with one or more other users' device(s) via network 106 and a backend 108, using one or more backend applications 110. The backend 108 (backend application(s) 110) may act as a persistent store through which users 102 share data.

As will be described in greater detail below, an interaction between a set of one or more users 102 is referred to herein as a “conversation.” In some cases a user may have a so-called “self-conversation,” in which case the user's device(s) may be considered to be communicating with each other. In the case of a self-conversation, the backend 108 may be considered to be acting as a persistent store within which a user maintains that user's self-conversation and through which that user's device(s) can view and participate in that user's self-conversation.

The devices 104 can be any kind of computing device, including mobile devices (e.g., phones, tablets, etc.), computers (e.g., desktops, laptops, etc.), and the like. Each device preferably includes at least at one display and at least some input mechanism. The display and input mechanism may be separate (as in the case, e.g., of a desktop computer and detached keyboard and mouse), or integrated (as in the case, e.g., of a tablet device such as an iPad or the like). The term “mouse” is used here to refer to any component or mechanism the may be used to position a cursor on a display and, optionally, to interact with the computer. A mouse may include a touchpad that supports various gestures. A mouse may be integrated into or separate from the other parts of the device. A device may have multiple displays and multiple input devices.

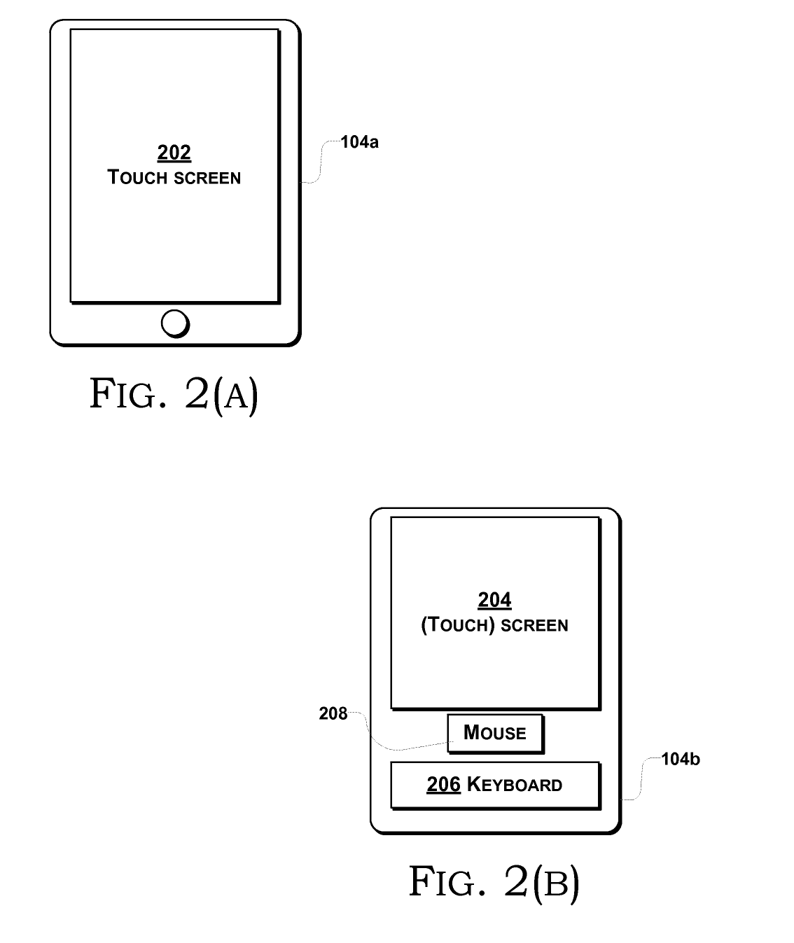

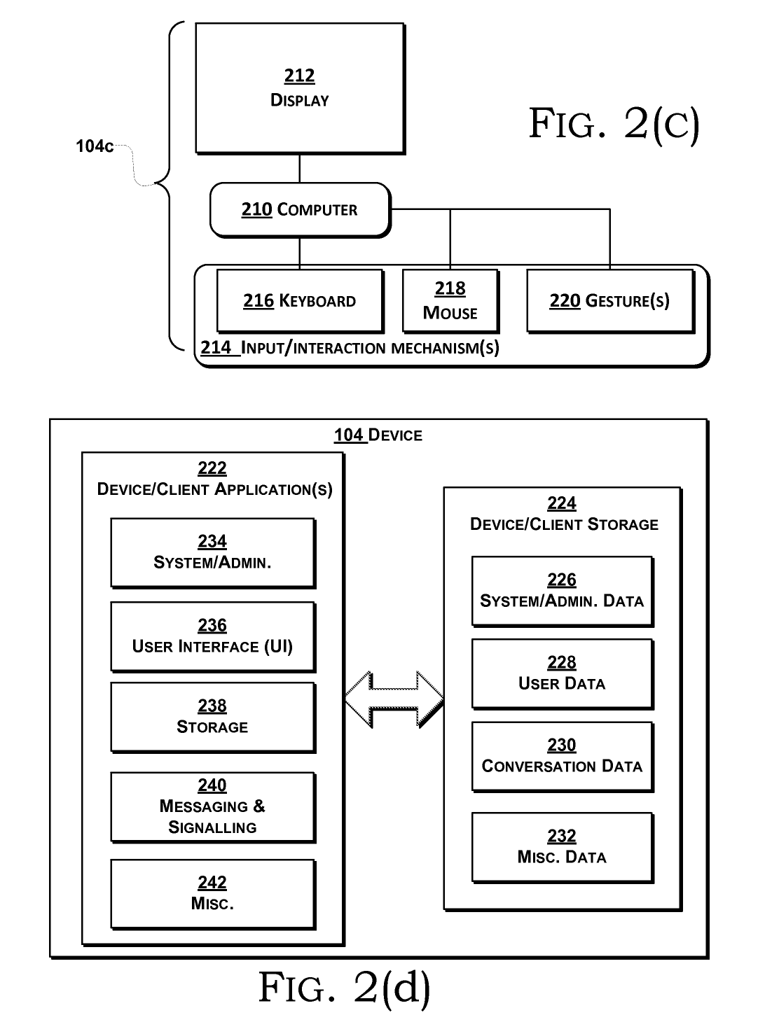

FIGS. 2(A)-2(C) show examples of devices 104a, 104b, and 104c, respectively, that may be used within the system/framework 100. These may correspond, e.g., to some of the devices 104 in FIG. 1. Exemplary device 104a (FIG. 2(A)) has an integrated display and input mechanism in the form of touch screen 202. The device 104a is integrated into a single component, e.g., a smartphone, a tablet computer, or the like. The device 104a may support a software (or virtual) keyboard (VKB). Exemplary device 104b (FIG. 2(B)) is also integrated into a single component, but, in addition to a screen 204 (which may be a touch screen), the device includes a keyboard 206 and an integrated mouse 208 (e.g., an integrated device such as a trackball or track pad or the like that supports movement of a cursor on the screen 204). The keyboard may be a hardware keyboard (e.g., as in the case of a BlackBerry phone). The screen 204 may be a touch screen and may also support a virtual keyboard (VKB).

The exemplary device 104c (FIG. 2(C)) comprises multiple components, including a computer 210, a computer monitor 212, and input/interaction mechanism(s) 214, such as, e.g., a keyboard 216 and/or a mouse 218, and/or gesture recognition mechanism 220. Although the various components of device 104c are shown connected by lines in the drawing, it should be appreciated the connection between some or all of the components may be wireless. Some or all of these components may be integrated into a single physical device or appliance (e.g., a laptop computer), or they may all be separate components (e.g., a desktop computer). As another example, a device may be integrated into a television or a set-top box or the like. Thus, e.g., with reference again to FIG. 2(C), the display 212 may be a television monitor and the computer 210 may be integrated fully or partially into the monitor. In this example, the input/interaction mechanisms 214 (e.g., keyboard 216 and mouse 218) may be separate components connecting to the computer 210 via wired and/or wireless communication (e.g., via Bluetooth or the like). In some cases, the input/interaction mechanisms 214 may be fully or partially integrated into a remote control device or the like. These input/interaction mechanisms 214 may use virtual keyboards generated, at least in part, by the computer 210 on the display 212.

Those of ordinary skill in the art will realize and understand, upon reading this description, that the exemplary devices 104a and 104b in FIGS. 2(A)-2(B) may be considered to be instances of the device 104c shown in FIG. 2(C).

It should be appreciated that these exemplary devices are shown here to aid in this description, and are not intended to limit the scope of the system in any way. Other devices may be used and are contemplated herein.

FIG. 2(D) shows logical aspects of a typical device 104 (FIG. 1), including device/client applications 222 interacting and operating with device/client storage 224. Device/client storage 224 may include system/administrative data 226, user data 228, conversation data 230, and other miscellaneous data 232. The device/client application(s) 222 may include system/administrative applications 234, user interface (UI) applications 236, storage applications 238, messaging and signaling applications 240, and other miscellaneous applications 242. The categorization of data in storage 224 is made for the purposes of aiding this description, and those of ordinary skill in the art will realize and appreciate, upon reading this description, that different and/or other categorizations of the data may be used. It should also be appreciated any particular item of data may categorized in more than one way. Similarly, it should be appreciated that different and/or other categorizations of the device/client applications 222 may be used and furthermore, that any particular application may be categorized in more than one way.

Conversations

Recall from above that the term “conversation” is used herein to refer to an ongoing interaction between a set of one or more users. In some aspects, a conversation may be considered to be a time-ordered sequence of events and associated event information or messages. The first event occurs when the conversation is started, and subsequent events are added to the conversation in time order. The time of an event in a conversation is preferably the time at which the event occurred on the backend.

Events in a conversation may be represented as or considered to be objects, and thus a conversation may be considered to be a time-ordered sequence of objects. An object (and therefore a conversation) may include or represent text, images, video, audio, files, and other assets. As used herein, an asset refers to anything in a conversation, e.g., images, videos, audio, links (e.g., URLs or URIs) and other objects of interest related to a conversation. A conversation may also include system information and messages (which may be text). In some aspects, a conversation may be considered to be a timeline with associated objects.

An object may contain the actual data of the conversation (e.g., a text message) associated with the corresponding event, or it may contain a link or reference to the actual data or a way in which the actual data may be obtained. The link may be to another location in the system 100 (e.g., in the backend 108) or it may be external. For the sake of this discussion, a conversation object that contains the actual conversation data is referred to as a direct object, and a conversation object that contains a link or reference to the data (or some other way to obtain the data) for the conversation is referred to as an indirect or reference object. A direct object contains, within the object, the information needed to render that portion of the conversation, whereas an indirect object typically requires additional access to obtain the information needed to render the corresponding portion of the conversation. Thus, using this terminology, an object may be a direct object or an indirect object.

As used herein, the term “render” (or “rendering”) with respect to data refers to presenting those data in some manner, preferably appropriate for the data. For example, a device may render text data (data representing text) as text on a screen of the device, whereas the device may render image data (data representing an image) as an image on a screen of the display, and the device may render audio data (data representing an audio signal) as sound played through a speaker of the device (or through a speaker or driver somehow connected to the device), and a device may render video data (data representing video content) as video images on a screen of the device (or somehow connected to the device). The list of examples is not intended to limit the types of data that devices in the system can render, and the system is not limited by the manner in which content is rendered.

It should be appreciated that a particular implementation may use only direct objects, only indirect objects, or a combination thereof. It should also be appreciated that any particular conversation may comprise direct objects, indirect objects, or any combination thereof. The determination of which conversation data are treated as direct objects and which as indirect objects may be made, e.g., based on the size or kind of the data and on other factors affecting efficiency of transmission, storage, and/or access. For example, certain types of data may be treated as indirect objects because they are typically large (e.g., video or images) and/or because they require special rendering or delivery techniques (e.g., streaming).

As used herein, the term “message” refers to an object or its (direct or indirect) contents. Thus, for a direct object that includes text, the message is the text in that direct object, whereas for an indirect object that refers to an asset, the message is the asset referred to by the indirect object.

In a presently preferred implementation, conversations may use a combination of direct and indirect objects, where the direct objects are used for text messages (including system messages, if applicable) and the indirect objects are used for all other assets. In some cases, text messages may be indirect objects, depending on their size (that is, an asset may also include or comprise a text message). It should be appreciated that even though an asset may be referenced via an indirect object, that asset is considered to be contained in a conversation and may be rendered (e.g., displayed) as part of (or apart from) a conversation.

Each device should be able to render each asset in a conversation in some manner.

It should be appreciated that the assets in a conversation (i.e., the assets referenced by indirect objects in the conversation) may be of different types (e.g., audio, pictures, video, files, etc.), and that the assets may not all be of the same size, or stored in the same place or in the same way.

As used herein, a user participating in a conversation is said to be conversing or engaging in that conversation. The term “converse” or “conversing” may include, without any limitation, adding any kind of content or object to a conversation, and removing or modifying any kind of content or object within a conversation. It should be appreciated that the terms “converse” and “conversing” include active and passive participation (e.g., viewing or reading a conversation). It should further be appreciated that the system is not limited by the type of objects in a conversation or by the manner in which such objects are included in or rendered within a conversation.

The User Interface (UI)

Clients (users' devices 104) interact with each other and the system 100 via the backend 108. These interactions generally take place, at least in part, using a user interface (UI) application 236 (FIG. 2(D)) running on each client (device 104, FIG. 1).

A user of a device 104 uses the UI on that device to interact with other applications on the device. In a general case, a user's interaction with the UI causes the UI to provide information (e.g., instructions, commands, or any kind of input) to other applications. And other applications' interactions with the UI cause the UI to present information to the user (e.g., on the screen of the device 104, via an audio system associated with the device, etc.).

A UI is implemented, at least in part, on a device 104 and preferably uses the device's display(s) and input/interaction mechanism(s) (e.g., 214, FIG. 2(C)). Use of a UI may require selection of items, navigation between views, and input of information. It should be appreciated that different devices may support different techniques for presentation of and user interaction with the UI. For example, a device with an integrated touch screen (e.g., device 104a as shown in FIG. 2(A)) may display UI information on the touch screen 202, and accept user input (for navigation, selection, input, etc.) using the touch screen (e.g., with a software/virtual keyboard—VKB—for some types of input). A device with an integrated screen, keyboard, and mouse (e.g., device 104b as shown in FIG. 2(B)) may display UI information on the screen 204, and accept user input using the hardware keyboard 206 and hardware mouse 208. If the screen/display 204 is also a touch screen display, then user interactions with the UI may use the screen instead of or in addition to the keyboard 206 and mouse 208. A device with separate components (e.g., some instances of device 104c of FIG. 2(C)) may display UI information on the display 212 and accept user input to the UI using input/interaction mechanism(s) 214 (e.g., the keyboard 216 and/or mouse 218 and/or gesture mechanism 220).

UI Interactions

A UI presents information to a user, preferably by rendering the information in the form of text and/or graphics (including drawings, pictures, icons, photographs, etc.) on the display(s) of the user's device(s). The UI 236 preferably includes or has access to rendering mechanism(s) appropriate to the various kinds of data it may be required to render. For example, the UI 236 may include or have access to one or more mechanisms for text rendering, image rendering, sound rendering, etc. These rendering mechanisms may be included in the device/client application(s) 222.

The user may interact with the UI by variously selecting regions of the UI (e.g., corresponding to certain desired choices or functionality), by inputting information via the UI (e.g., entering text, pictures, etc.), and performing acts (e.g., with the mouse or keyboard) to affect movement within the UI (e.g., navigation within and among different views offered by the UI).

The UI application(s) 236 (FIG. 2(D)) preferably determine (or know) the type and capability of the device on which it is running, and the UI may vary its presentation of views depending on the device. For example, the UI presented on a touch screen display on a smartphone may have the same functionality as the UI presented on the display of general-purpose desktop or laptop computer, but the navigation choices and other information may be presented differently.

It should be appreciated that, depending on the device, the UI 236 may not actually display information corresponding to navigation, and may rely on unmarked parts of the screen and/or gestures to provide navigation support. For example, different areas of a screen may be allocated for various functions (e.g., bottom for input, top for search, etc.), and the UI may not actually display information about these regions or their potential functionality. It should be appreciated that the functionality associated with a particular area or portion of a display screen may change, e.g., depending on the state of the UI.

As has been explained, and as will be apparent to those of ordinary skill in the art, upon reading this description, the manner in which UI interactions take place will depend on the type of device and interface mechanisms it provides.

As used herein, in the context of a UI, the term “select” (or “selecting”) refers to the act of a user selecting an item or region of a UI view displayed on a display/screen of the user's device. The user may use whatever mechanism(s) the device provides to position the cursor (which may or may not be visible) appropriately and to make a desired selection. For example, a touch screen 202 on device 104a may be used for both positioning and selection, whereas device 104b may require the mouse 208 (and/or keyboard 206) to position a cursor on the display 204 and then to select an item or region on that display. In the case of a touch screen display, selection may be made by tapping the display in the appropriate region. In the case of a device such as 104c, selection may be made using a mouse click or the like.

Touch Screen Interfaces and Gestures

Touch-screen devices (e.g., an iPad, iPhone, etc.) may recognize and support various kinds of touch interactions, including gestures, such as touching, pinching, tapping, and swiping. These gestures may be used to move within and among views of a UI.

Views

In a presently preferred implementation the UI (implemented, e.g., using UI interface application(s) 236 on device 104) comprises a number of views. These views may be considered to correspond to various states in which the device/client application(s) 222 may be.

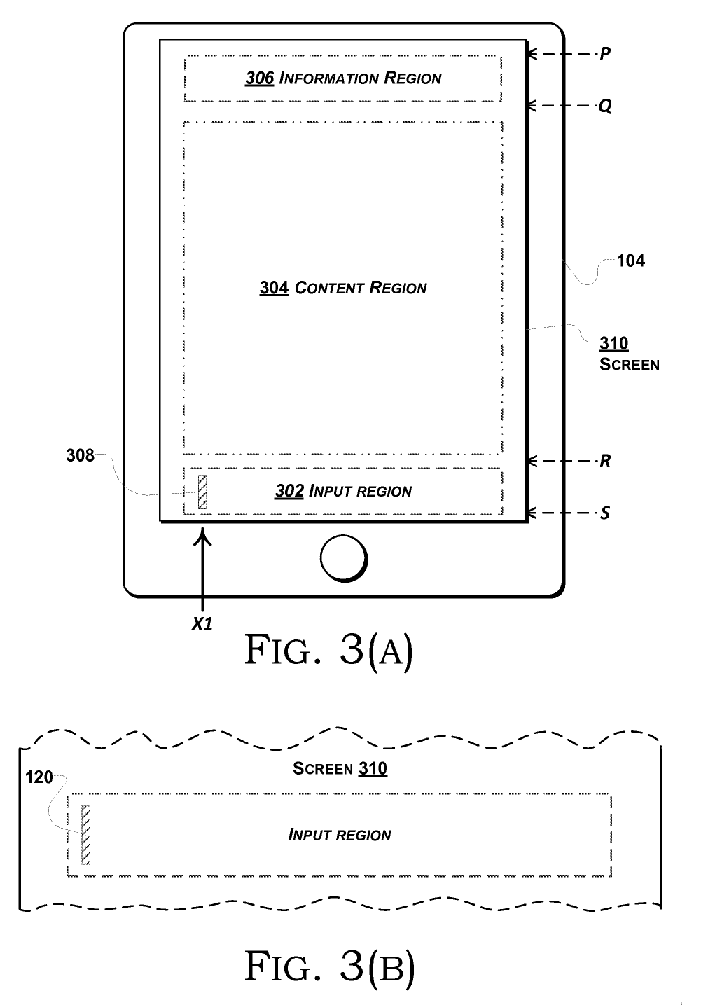

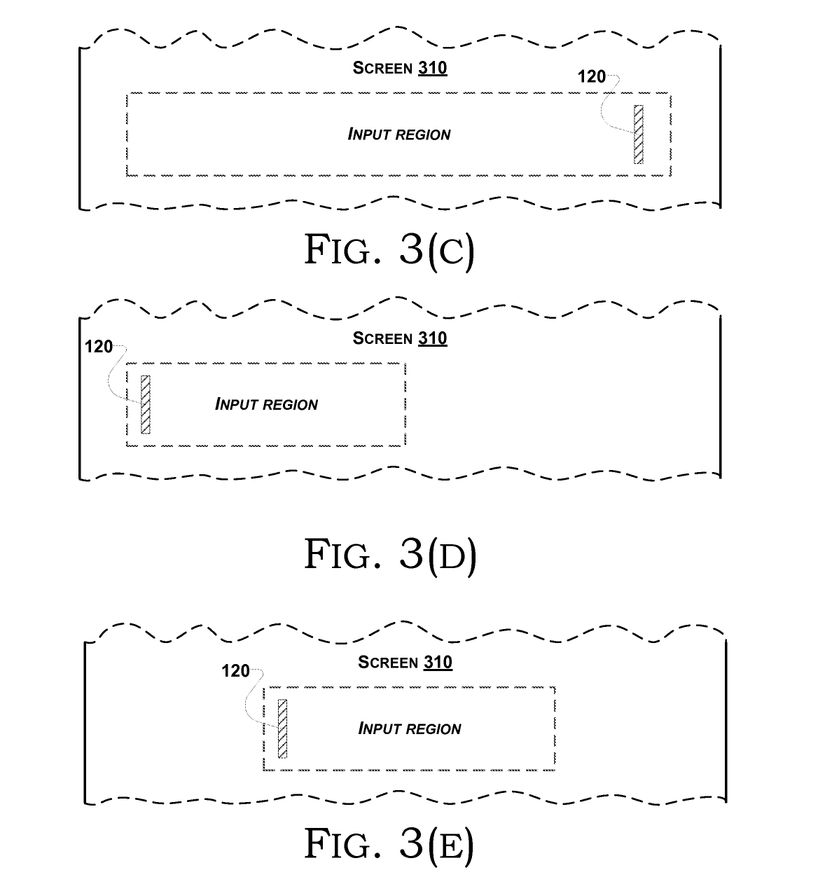

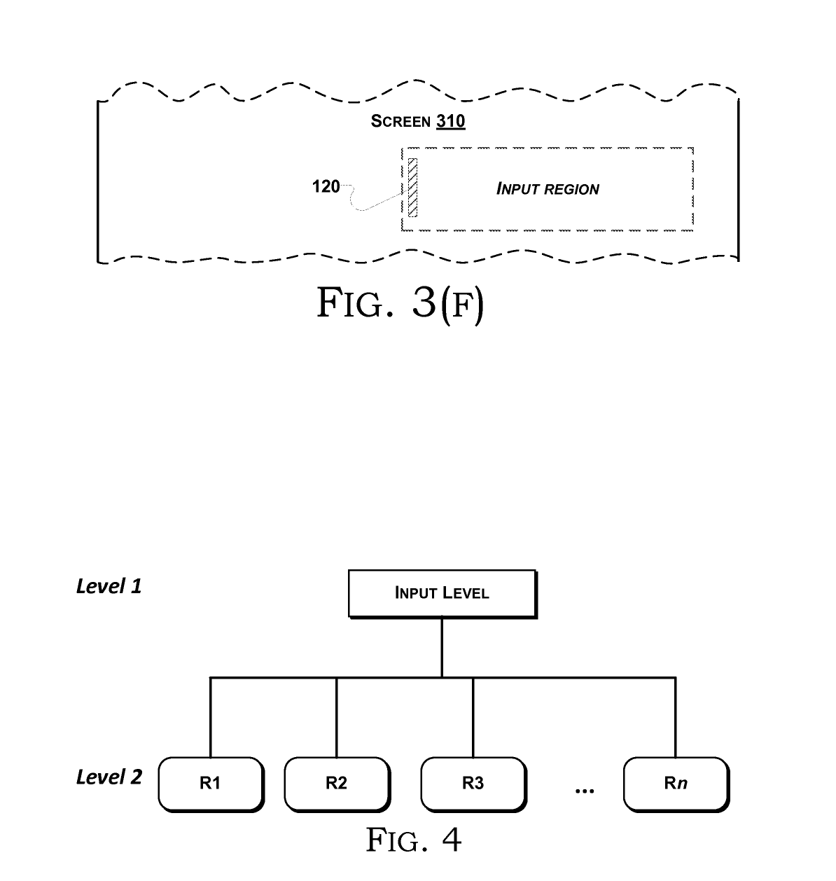

FIG. 3(A) shows an exemplary view 300 of a UI supported by user interface (UI) 236 of a device 104. The view 300 may be displayed on the display mechanism of the device (e.g., touch screen 202 of exemplary device 104a in FIG. 2(A), screen 204 of exemplary device 104b in FIG. 2(B), display 212 of exemplary device 104c in FIG. 2(C), etc.). In FIG. 3(A) the view is shown on the screen 310 of device 104. In order to simplify the drawings, and for the sake of explanation, in subsequent drawings, the display mechanism (e.g., screen) and other features of the underlying device on which the view is displayed may not be shown.

With reference to the drawing in FIG. 3(A), an exemplary view 300 comprises an input region 302, a content region 304, and an information region 306. Although shown in the drawing at the bottom of the screen, the input region 302 may be located anywhere on the screen, and its location may vary during operation of the system. For example, in a conversation view, the input region may be located at the bottom of the screen. However, during a conversation, the location of the input region may change.

Although only one input region is shown, it should be appreciated that that multiple input regions, possibly having different functionality, may be provided on a particular view. For example, a view provided by the GUI may have a search input region and another content input region.

The information region 306 may provide, e.g., a caption or subject for the content (e.g., when the view 300 is a conversation view, the information region 306 may list the conversation participants). In some cases the information region 306 may be omitted. In the drawings the various regions are shown with dashed lines indicating their positions on the display. It should be appreciated that in preferred implementations, the actual regions are not outlined or highlighted on the display.

In preferred implementations (as shown, e.g., in FIGS. 3(A)-3(B)) a boundary of the input region 302 is indicated by a cursor 308 (e.g., a vertical bar rendered on the left side of the input region 302, such as at horizontal position X1 in FIG. 3(A)). For input of languages that are written from right to left, the cursor 308 may default to a position on the right side of the input region 302, as shown in FIG. 3(C).

In the case, e.g., of a conversation view, the input region 302 may use an area on the bottom of the screen (between vertical positions R and S in FIG. 3(A)), the conversation region 304 uses an area of the screen between vertical positions Q and S, and the information region 306 (if present) uses an on the top of the screen (between vertical positions P and Q in FIG. 3(B)). In other views (or other states of the conversation view), the input region may be located elsewhere on the screen.

In other embodiments, the positions of the input region 302 and/or information region 306 may be in alternate positions (e.g., both at the top, both at the bottom, or in exchanged positions).

Size and Scale

Although some regions are shown in the drawings as having gaps between them, it should be appreciated that in an actual implementation, there may not be gaps between some or all regions, and some or all of the regions may abut adjacent regions. It should also be appreciated that the regions in the drawings are not drawn to scale and that the relative sizes of the regions in the drawings are exemplary and not limiting.

Menus and States

A device 104 running the device/client application(s) 222 may be in various states, and the UI 236 may present different views for different states. The UI 236 supports a user moving between views (states) by various interactions. In certain operational states, a user may have a number of interaction choices that may cause the application(s) 222 to transition to a different state or to transition within their current state. Some of these choices may logically be viewed as menu selections. For example, as shown in FIG. 4(A), in a state (referred to in the drawing as “input state”), the user may be able to select one or more options (R1, R2, R3 . . . Rn). The functionality associated with each option may be a function of the current state and may vary dynamically.

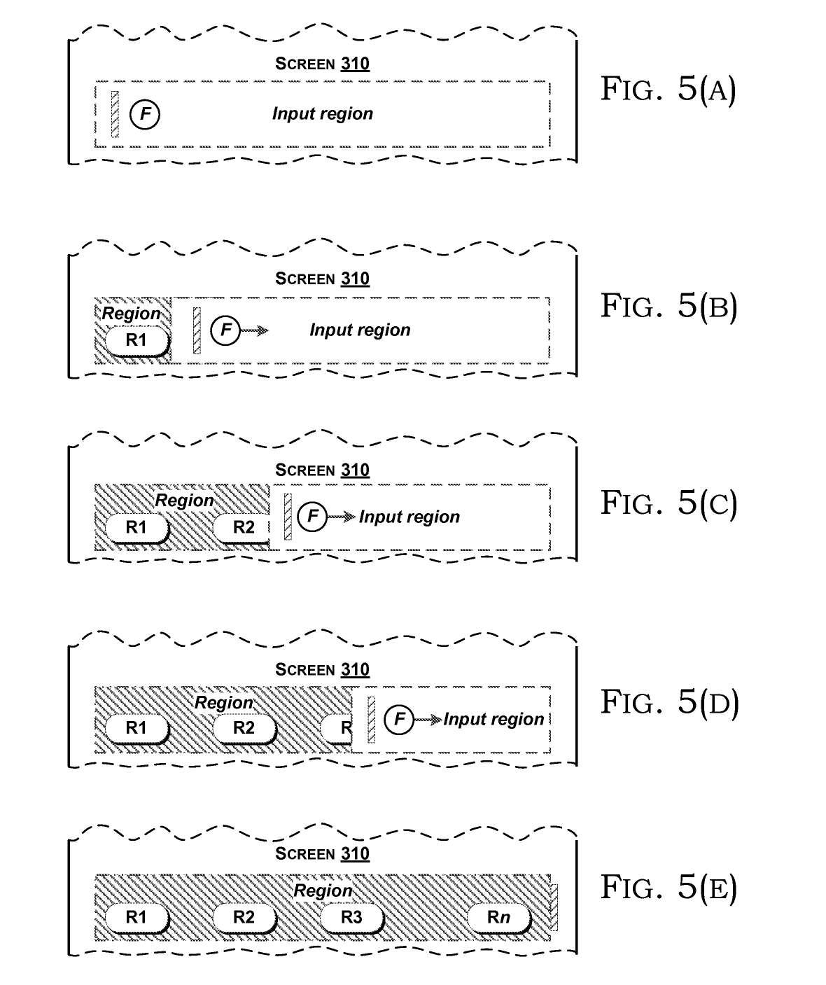

With reference now to FIGS. 5(A)-5(E), the UI 236 provides the user with access to various options (e.g., options R1, R2, R3 . . . Rn from the “menu” in FIG. 4(A)) by effectively sliding the input region. In the following drawings the circle with a letter “F” inside denotes a user's finger or other means of selecting a location on the screen 310. A circle with the letter “F” inside and an arrow denotes a user holding down their finger (or other means of selecting), and dragging in the direction of the arrow. In the remainder of this description the UI will be described with reference to a user using his finger to select, drag, etc. Those of ordinary skill in the art will appreciate and understand, upon reading this description, that the selection may be made in any known way, including with a special pen, with a mouse, with a keyboard, etc. It should therefore be appreciated that the use of the term “finger” is not intended to limit the scope of the invention in any way.

Thus, as shown in FIGS. 5(A)-5(E), using the UI 236, the user may hold down or select at a location substantially within the input region and to the left side of the region, preferably at or near the cursor (FIG. 5(A)), and drag the selected location to the right (e.g., using their finger). This dragging process exposes a region below the input region that contains various active regions R1, R2, . . . Rn (corresponding to the options R1, R2, R3 . . . Rn from the “menu” in FIG. 5(A)). As shown in FIG. 5(B), the process of dragging a location on the left side of the input region first exposes active region R1, then active region R2 (FIG. 5(C)), and so on until the input region has been dragged to the right (FIG. 5(E)), exposing the underlying active regions R1 . . . Rn. Once the user has reached substantially the right side of the input region (or has exposed the required active region), the user may lift his finger.

In a preferred implementation, an underlying region becomes active once some or all of that region has been exposed.

In some implementations the exposed region (and active regions) may remain exposed at whatever point the user lifts his finger. In some cases, the input region may re-cover the exposed region (e.g., by bouncing back) if the user does not drag more than some predetermined amount (e.g., 50% of the width of the input region) to the right.

Although the example given here shows active regions R1 . . . Rn, it should be appreciated that in some cases only one active region may be provided. Thus, the range R1 . . . Rn may actually only be R1 (i.e., n=1). In general, unless stated otherwise, any sequence or range described herein may have only one element.

As used herein, in the context of the UI 236, a region on a screen is considered “active” if that region is selectable within the UI to cause some action to take place, either within the UI or by other parts of the system. Thus, e.g., and without limitation, a region is active if tapping that region causes the UI to make something happen. It should be appreciated that an active region need not be marked nor have its boundaries marked. In addition, the input region need not be marked nor have its boundaries marked on the screen.

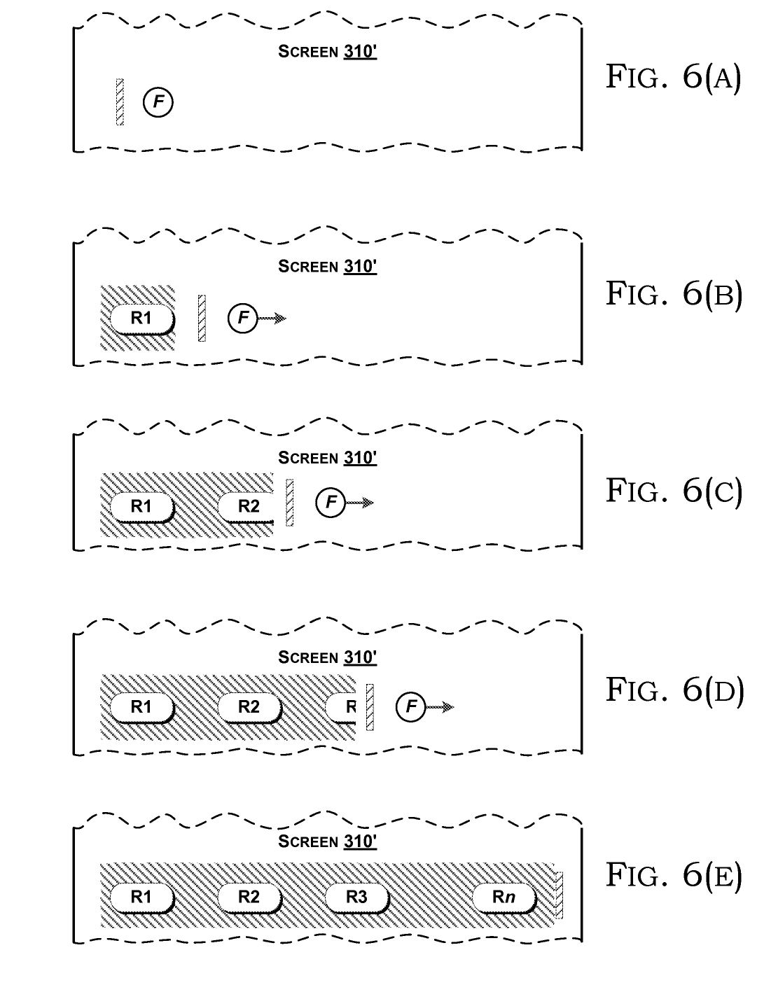

Thus, as shown in the example in FIGS. 6(A)-6(E), the input region on the screen 310′ is not marked. The user selects a location at or near the cursor (FIG. 6(A)) and drags that location to the right (FIGS. 6(B)-6(E)), exposing the underlying options (active regions) R1 . . . Rn.

FIGS. 6(A)-6(E) are similar to FIGS. 5(A)-5(E), except that they highlight the fact that the region boundaries may not be shown on the screen. In both sets of drawings (FIGS. 5(A)-5(E) and 6(A)-6(E)) the underlying region containing the n active regions (n≧1) is shown using diagonal hatching. This hatching effect is provided in the drawings only to show that there are two logically distinct regions, one corresponding to the input level (Level 1 in FIG. 4), and the other corresponding to the active options R1 . . . Rn (Level 2 in FIG. 4).

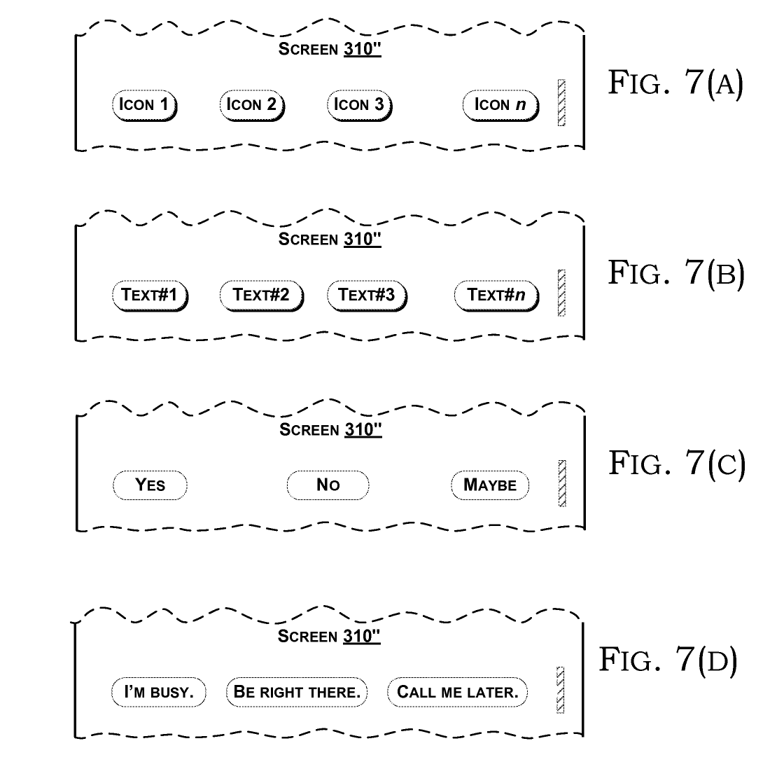

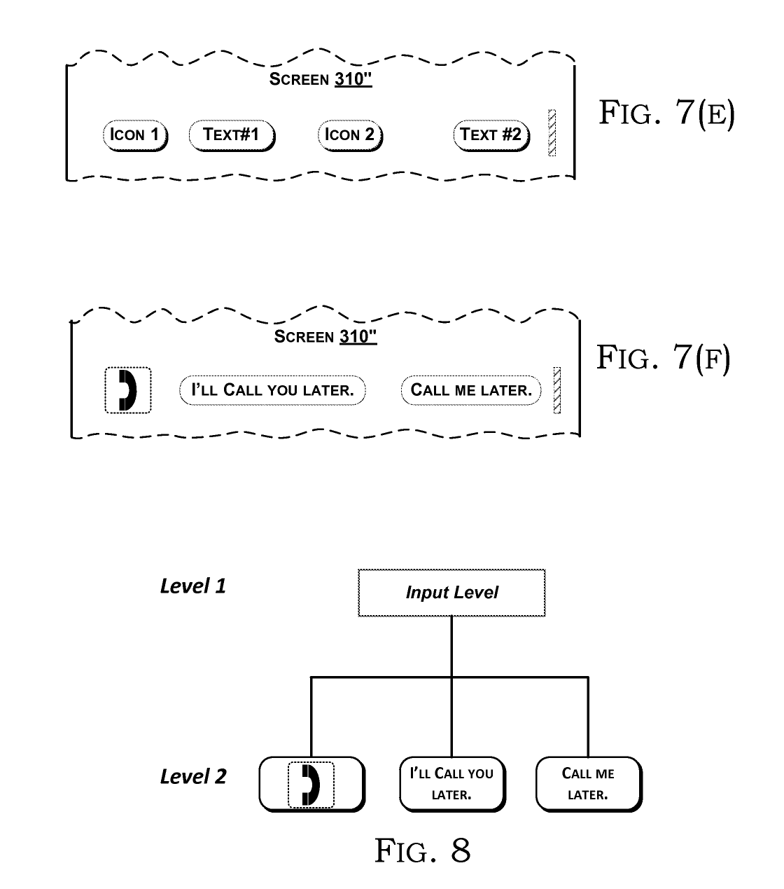

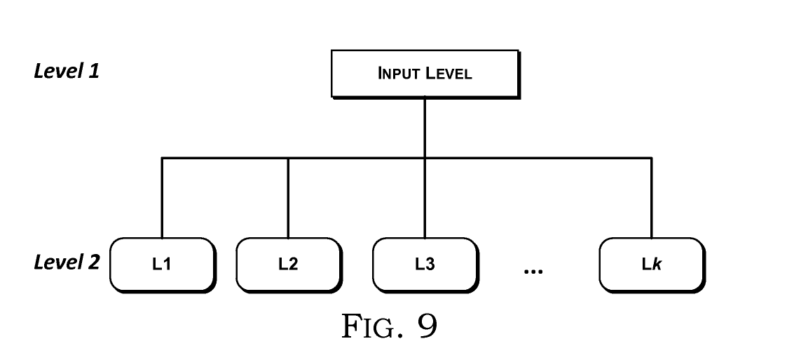

Each active region (denoted Ri in FIGS. 5(A)-5(E) and 6(A)-6(E)) may be represented by an icon or text or both. Thus, e.g., as shown in FIG. 7(A) (which corresponds to an example set of active options R1 . . . Rn in FIG. 5(E) or 6(E)), the exposed active regions may each be represented by a corresponding icon (denoted Icon 1, Icon 2, Icon 3, . . . Icon n in the drawing). Using the UI 236, the user may select one of the icons (in a known manner, e.g., by clicking or tapping on the icon) in order to invoke the underlying functionality associated with that icon. The UI 236 will determine which icon has been selected and will invoke (or cause the device/client application(s) 222) to invoke the corresponding functionality.

In the example shown in FIG. 7(B) the active options R1 . . . Rn comprise text (denoted Text#1, Text#2, Text#3, . . . Text#n in the drawing). Examples of such text are shown in FIGS. 7(C)-7(D). When an active option comprises text, selection of the option by the user (using the UI 236) preferably causes the corresponding text to be inserted at the input cursors current location. Thus, e.g., with reference to FIG. 7(C), if the user selects the text “Maybe”, then the word “Maybe” will be inserted by the UI 236 at the input cursor's location in the input region (preferably the location of the cursor before the input region was slid over). Similarly, with reference to the example in FIG. 7(D), if the user selects the text “Be right there.”, then the phrase “Be right there.” will be inserted at the input cursor's current location in the input region (preferably the location of the cursor before the input region was slid over).

In the drawings the various active text options are show with dotted lines around them. These lines are shown for the purpose of this explanation. It should be appreciated that in an actual implementation the text regions may or may not be outlined or highlighted in some way. However, when there are multiple text options exposed, it is preferable to distinguish them in some way (e.g., by outlining or shading them).

FIGS. 7(E)-7(F) show examples of a mixture of active text and icon regions. In the example in FIG. 7(F), the underlying region (under the input region) has three active options, namely an icon (of a telephone), the text “I'll call you later.”, and the text “Call me later.” These options may be available, e.g., when another user asks the user of this device if he is available to talk (i.e., for voice interaction). The user may select the icon of the phone to initiate the voice interaction (e.g., a call with the first user), or may select one of the text options to send the corresponding text message to the first user. It should be appreciated that in all cases, the user may ignore the underlying options and slide the cursor back to the right to get back the input region.

The exemplary options in FIG. 7(F) correspond to the menu hierarchy shown in FIG. 8.

In addition to (or instead of) an underlying set of options when the user slides an input region to the right, the UI may also (or instead) provide a set of underlying options when the input region is slid to the left. Thus, as shown, for example, in FIG. 9(A), the UI may support a set of k “menu” options (L1 . . . Lk) when the input region is slid to the left.

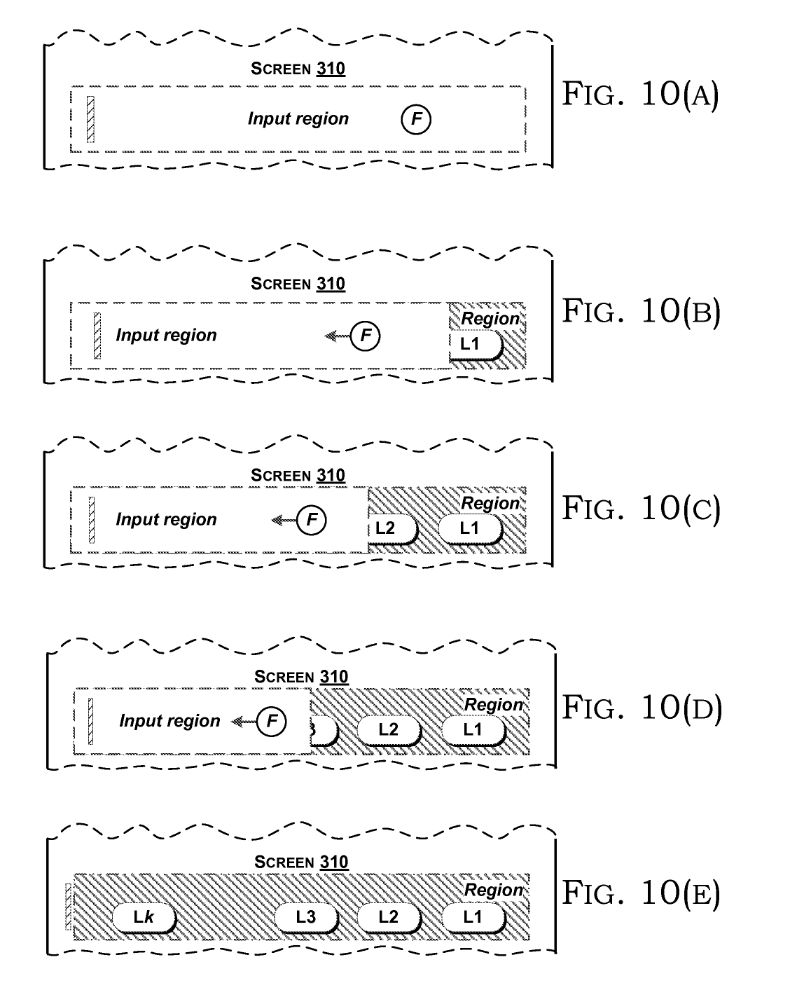

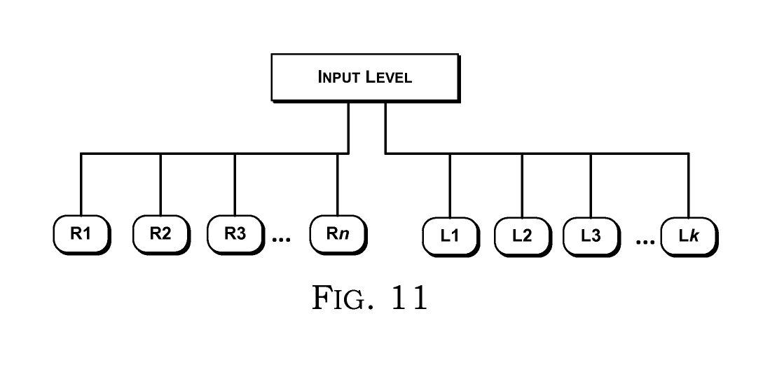

The input region may be slid to the left in a similar manner to the way it may be slid to right. For example, as shown in FIG. 10(A), a user may select a location on the right side of the input region (denoted in the drawing by the letter “F” in a circle), and drag to the left (denoted by the arrow in FIGS. 10(3)-10(D)), exposing the underlying active region(s) L1 . . . Lk.

As with the exemplary regions R1 . . . Rn described above (e.g., FIGS. 5(A)-5(E), 6(A)-6(E)), each active region Li (i=1 . . . k) may be represented by an icon and or text. And, as with the regions R1 . . . Rn described above, the user may interact with the exposed active regions L1 . . . Lk in the same manner. For example, if a region Li is denoted on the screen by an icon, the user's selection of that icon will cause the UI 236 to invoke (or cause to be invoked) functionality associated with that icon; and, if a region Li corresponds to text, the user's selection of that region will cause the UI 236 to insert the corresponding text at the cursors current location. Selection of an active region may perform or invoke any function, e.g., it may expose another set of menus, put the UI in a different state, etc.

In some embodiments, a menu hierarchy such as shown in FIG. 11 may be supported, in which regions R1 . . . Rn are exposed and become active when the input region is slid (or otherwise moved) to the right, and regions L1 . . . Lk are exposed and become active when the input region is slid or otherwise moved to the right.

In general, each active region Ri (or Li) has a corresponding action associated therewith, such that when the region is selected, the UI performs that corresponding action (if the action is associated with the UI) or causes the action to be performed (e.g., by device/client application(s) 222). When an active region is a text region (i.e., contains text), the corresponding action associated with the region (and performed by the UI 236) may be to insert that text at the cursor's current location.

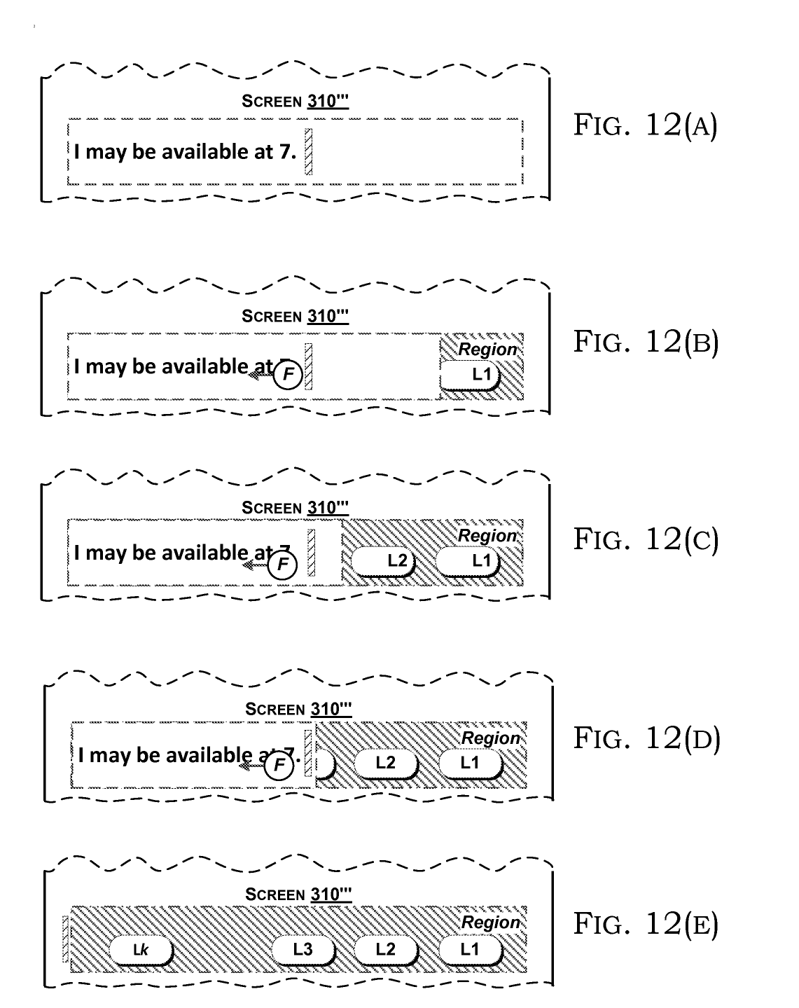

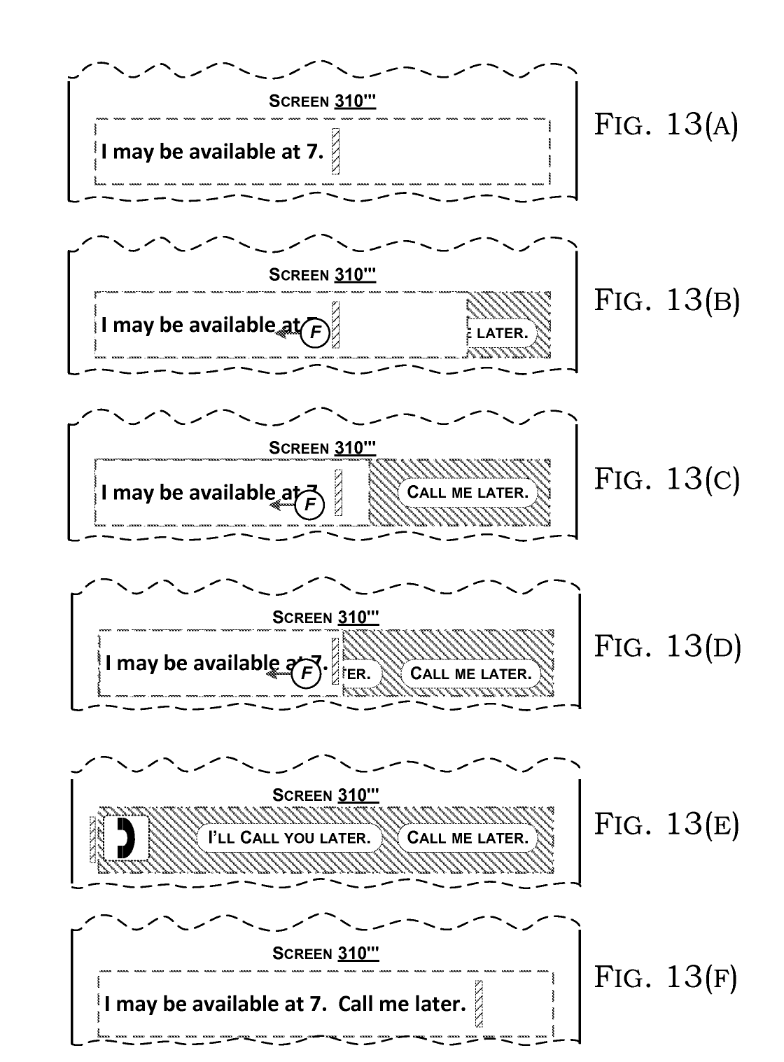

In the drawings shown so far, the input cursor (denoted in the drawings by a vertical bar) is at the left side of the input region when the region is slid (or moved) to expose an underlying region with active regions. It should be appreciated, however, that in general the input cursor may be anywhere in the input region when the input region is slid over (to the left or right) to expose an underlying active region. For example, as shown in FIGS. 12(A)-12(E) the input cursor may be away from the left edge when sliding begins. In the example in FIG. 12(A), the user is entering text (and has already entered “I may be available at 7.”) when he selects a location in the input region (denoted “F” in FIG. 12(B)) and slides the input region to the left to expose and make active the underlying regions L1, L2, . . . .

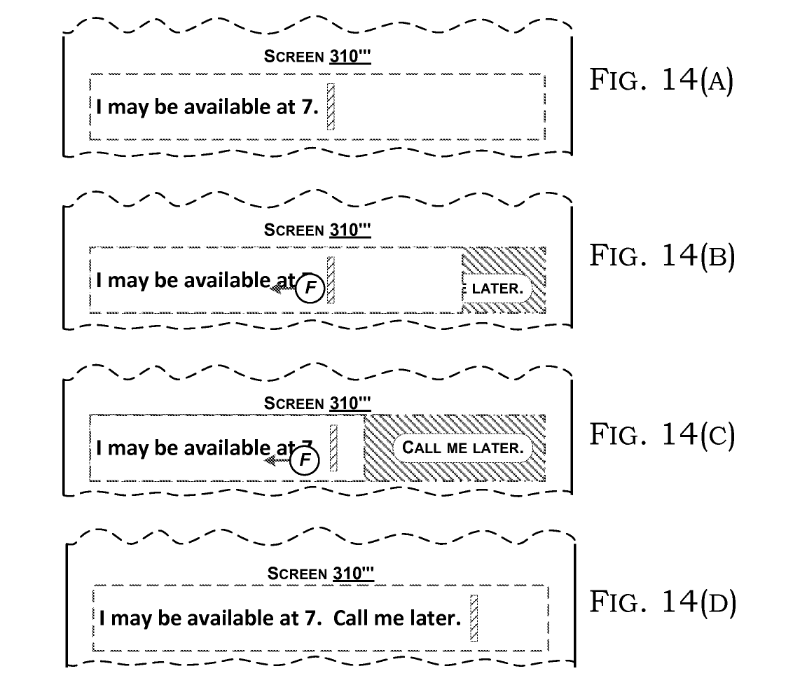

With reference to the example in FIGS. 13(A)-13(F), if, e.g., the underlying regions correspond to the three regions shown in FIG. 13(E), then if the user selects the phone icon, the UI 236 will begin (or try to begin) a voice call with the user they are conversing with. If the user selects one of the two text regions, then that text will be inserted at the input cursor (preferably at the location of the input cursor before the sliding took place). For example, if the user selects option “Call me later.” from the active regions shown in FIG. 13(E), the corresponding text is inserted by the UI 236 at the input location (as shown in FIG. 12(G)). In other words, selection of the text region causes the UI 236 to insert the corresponding text in the current location of the input cursor; whereas selection of the phone icon will cause the UI 236 to invoke appropriate device/client application(s) 222 to initiate (or continue) a voice call with the other conversation participant.

As noted above, a region may become active as soon as some or all of that region is exposed. In preferred implementations, the UI 236 need not wait for an entire region to be exposed or for all underlying regions to be exposed before making a fully or partially exposed region active. For example, as shown in FIGS. 14(A)-14(D), the user may select the text option “Call me later.” As soon as that option is sufficiently displayed. While a text option may, in some implementations, have been active in FIG. 14(B), the user may, of course, decide to not select it until all of the text is exposed.

In FIGS. 3(A)-3(C), 5(A)-5(E), 6(A)-6(E), 7(A)-7(F), 10(A)-10(E), 12(A)-12(E), 13(A)-13(F), 14(A)-14(D), the input region is shown spanning a substantial horizontal portion of the screen 310. Those of ordinary skill in the art will appreciate and understand, upon reading this description, that the input region may span a much smaller portion of the screen 310 and need not be centered on the screen. For example, as shown in FIGS. 3(D)-3(F) respectively, the input region may be located towards the left, middle, or right of the screen 310. In general, it should be appreciated that the drawings present only example locations and sizes of the cursor and input region, and that a particular implementation may support multiple input region shapes, locations and/or sizes and multiple cursor shapes, locations and/or sizes.

### EXAMPLES

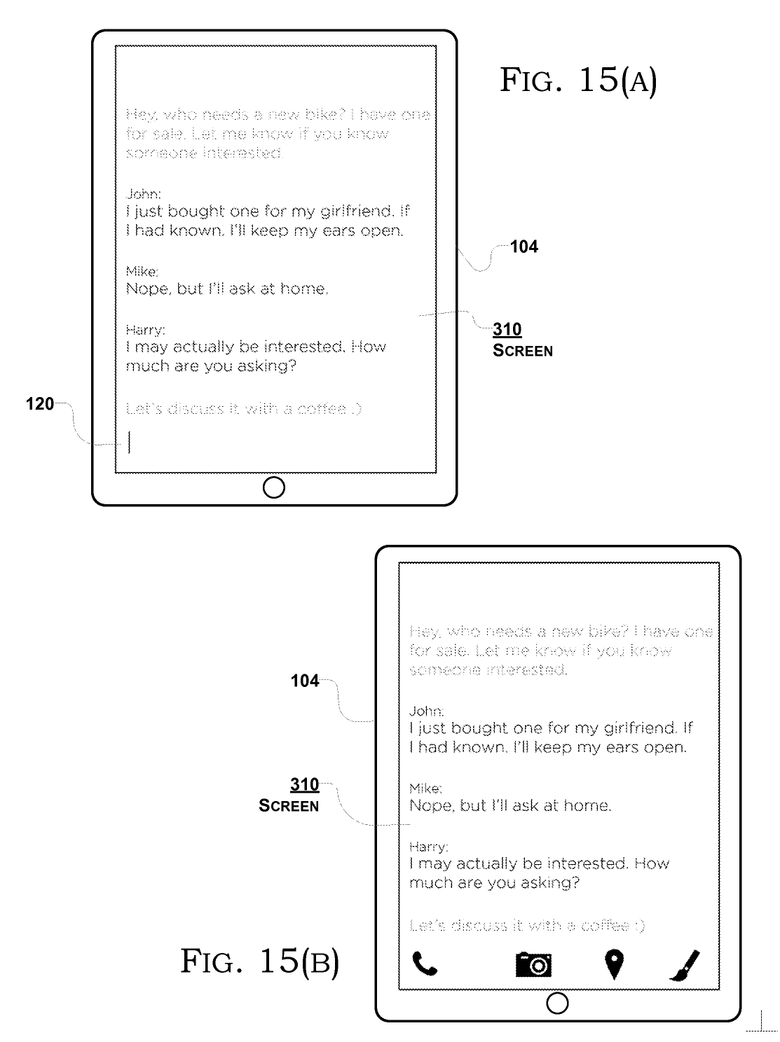

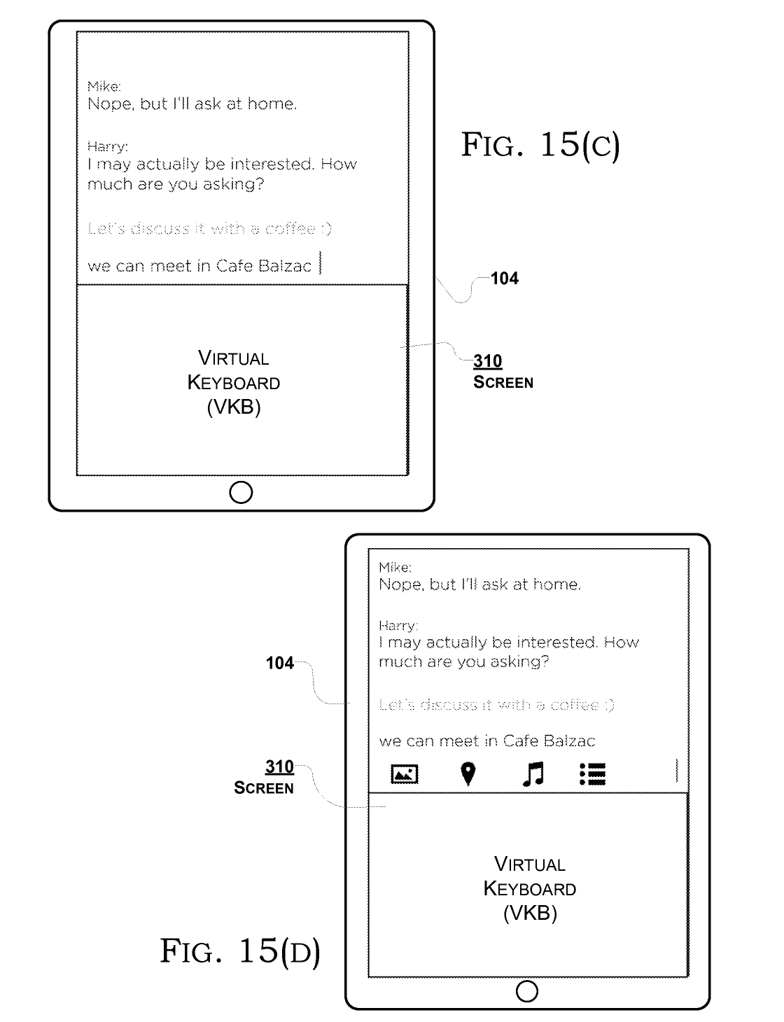

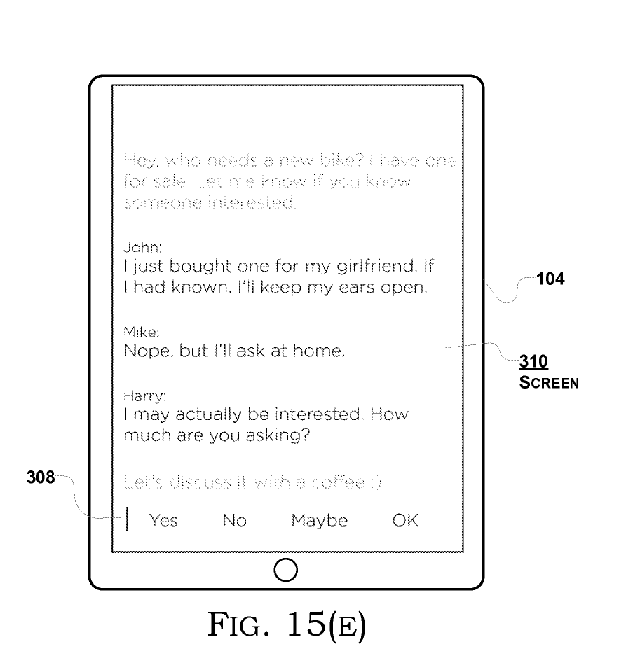

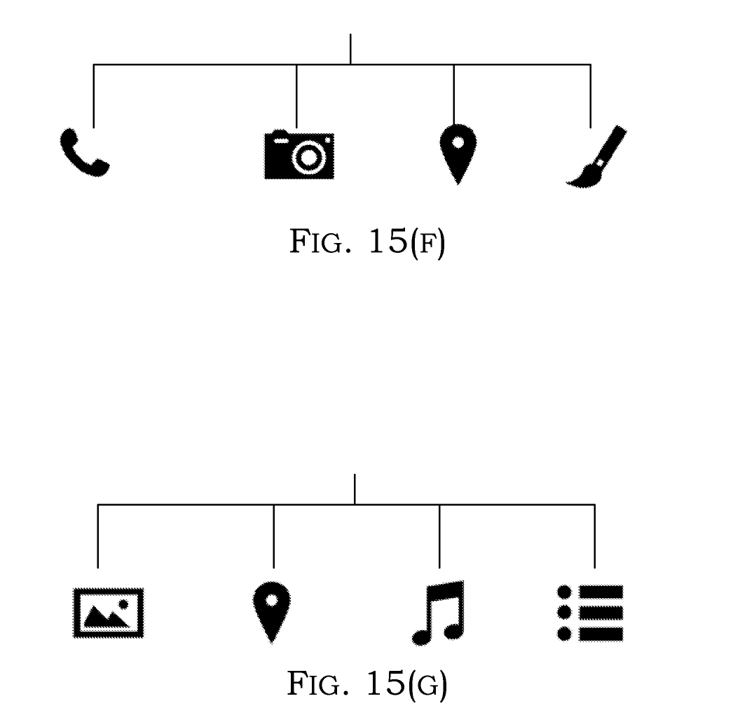

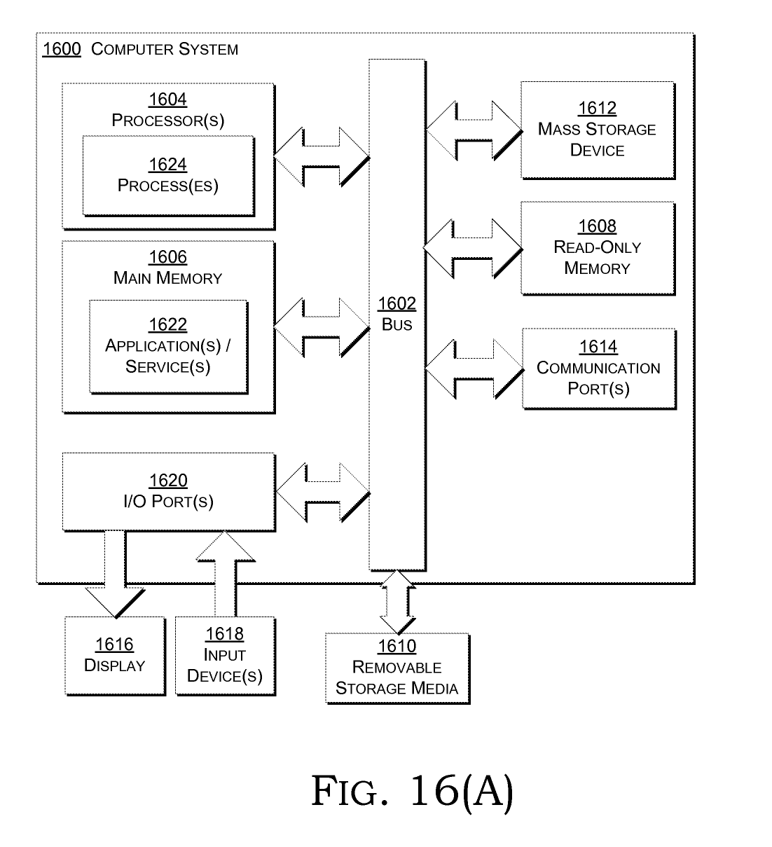

FIGS. 15(A)-15(E) are screens of exemplary implementations in accordance with embodiments hereof, and FIGS. 15(F)-15(G) depict menu hierarchies of the exemplary UIs of FIGS. 15(B) and 15(D), respectively. The screen examples shown in the drawings are depicted on the screen 310 of a device 104 such as, e.g., an Apple iPhone or the like. It should be appreciated that the UI operates on multiple devices and types of devices, and that the UI is not limited to smartphones, and that it may operated on different devices and types of devices (e.g., desktop computers, set-top boxes, laptop computers, etc.). It should be further be appreciated that these screen examples are intended to show aspects of the UI and related systems in operation, and are not intended to be limiting in any manner. Additionally, it should be appreciated that the text on the screens in FIGS. 15(A)-15(E) is merely exemplary of conversation text and is not intended to limit the UI or system in any way.

In the example shown in FIGS. 15(A)-15(B), the user in swipes the cursor 120 to the left to expose the UI options shown in FIG. 15(B) (corresponding to the menu hierarchy shown in FIG. 15(F)).

In the example shown in FIGS. 15(C)-15(D), while the user is entering text using the virtual keyboard (VKB) (in FIG. 15(C)), the user slides the cursor to expose the underlying UI icons (in FIG. 15(D), corresponding to the menu hierarchy shown in FIG. 15(G)).

In the example shown in FIG. 15(E), the user used the sliding cursor to expose a list of words (phrases: “Yes”, “No”, “Maybe”, “OK”).

An exemplary approach to message presentation is thus described. Those of ordinary skill in the art will realize and appreciate, upon reading this description, that different and/or other approaches may be used within a UI, and the system is not to be limited in any way by the approach(es) described here.

Although various exemplary UIs have been described above with reference to particular devices, those of ordinary skill in the art will realize and appreciate, upon reading this description, that the UIs described may operate on any computing device, including general computing devices and special purpose computing devices.

### Computing

The services, mechanisms, operations and acts shown and described above are implemented, at least in part, by software running on one or more computers or computer systems or user devices (e.g., devices 104a, 104b, 104c in FIGS. 2(A)-2(C), respectively). It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

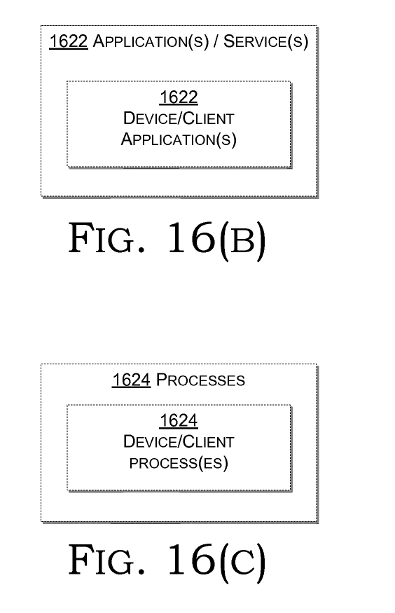

FIG. 16(A) is a schematic diagram of a computer system 1600 upon which embodiments of the present disclosure may be implemented and carried out.

According to the present example, the computer system 1600 includes a bus 1602 (i.e., interconnect), one or more processors 1604, one or more communications ports 1614, a main memory 1606, optional removable storage media 1610, read-only memory 1608, and a mass storage 1612. Communication port(s) 1614 may be connected to one or more networks (e.g., computer networks, cellular networks, etc.) by way of which the computer system 1600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1604 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1614 can be any of an RS-232 port for use with a modem based dial-up connection, a 10/100 Ethernet port, a Gigabit port using copper or fiber, or a USB port, and the like. Communications port(s) 1614 may be chosen depending on a network such as a Local Area Network (LAN), a Wide Area Network (WAN), a Content Delivery Network (CDN), or any network to which the computer system 1600 connects. The computer system 1600 may be in communication with peripheral devices (e.g., display screen 1616, input device(s) 1618) via Input/Output (I/O) port 1620. Some or all of the peripheral devices may be integrated into the computer system 1600, and the input device(s) 1618 may be integrated into the display screen 1616 (e.g., in the case of a touch screen).

Main memory 1606 can be Random Access Memory (RAM), or any other dynamic storage device(s) commonly known in the art. Read-only memory 1608 can be any static storage device(s) such as Programmable Read-Only Memory (PROM) chips for storing static information such as instructions for processor(s) 1604. Mass storage 1612 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1602 communicatively couples processor(s) 1604 with the other memory, storage and communications blocks. Bus 1602 can be a PCI/PCI-X, SCSI, a Universal Serial Bus (USB) based system bus (or other) depending on the storage devices used, and the like. Removable storage media 1610 can be any kind of external hard-drives, floppy drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 1606 is encoded with application(s) 1622 that support(s) the functionality as discussed herein (an application 1622 may be an application that provides some or all of the functionality of one or more of the mechanisms described herein). Application(s) 1622 (and/or other resources as described herein) can be embodied as software code such as data and/or logic instructions (e.g., code stored in the memory or on another computer readable medium such as a disk) that supports processing functionality according to different embodiments described herein.

For example, as shown in FIG. 16(B), application(s) 1622 may include device/client application(s) 1622 in FIG. 16(B) (corresponding to device/client application(s) 222 in FIG. 2(D)). As shown, e.g., in FIG. 2(D), device/client application(s) 222 (1622 in FIG. 16(B)) may include system/administrative applications 234, user interface (UI) applications 236, storage applications 238, messaging and signaling applications 240, and other miscellaneous applications 242.

During operation of one embodiment, processor(s) 1604 accesses main memory 1606, e.g., via the use of bus 1602 in order to launch, run, execute, interpret or otherwise perform the logic instructions of the application(s) 1622. Execution of application(s) 1622 produces processing functionality of the service(s) or mechanism(s) related to the application(s). In other words, the process(es) 1624 represents one or more portions of the application(s) 1622 performing within or upon the processor(s) 1604 in the computer system 1600.

For example, as shown in FIG. 16(C), process(es) 1624 may include device/client process(es) 1622, corresponding to one or more of the device/client application(s) 1622.

It should be noted that, in addition to the process(es) 1624 that carries (carry) out operations as discussed herein, other embodiments herein include the application 1622 itself (i.e., the un-executed or non-performing logic instructions and/or data). The application 1622 may be stored on a computer readable medium (e.g., a repository) such as a disk or in an optical medium. According to other embodiments, the application 1622 can also be stored in a memory type system such as in firmware, read only memory (ROM), or, as in this example, as executable code within the main memory 1606 (e.g., within Random Access Memory or RAM). For example, application 1622 may also be stored in removable storage media 1610, read-only memory 1608, and/or mass storage device 1612.

Those skilled in the art will understand that the computer system 1600 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A computer-implemented method, implemented by hardware in combination with software, the method operable on a device for use in a multimodal communication framework, the method comprising:
(A) providing, by a graphical user interface (GUI) on said device, said GUI being implemented by said hardware in combination with said software, a first selectable region on a screen of said device, said first region being at a first area of said screen;
(B) said GUI providing one or more second selectable regions on said screen of said device, said one or more second selectable regions being located on said screen at least partially in said first area of said screen,
wherein, in a first state of said GUI, said first selectable region is active and said one or more second selectable regions are inactive, and
wherein, in a second state of said GUI, at least one of said second selectable regions is active;
(C) while in said first state, in response to a first user gesture in said first selectable region, exposing at least some of said one or more second selectable regions and causing said GUI to be in said second state.

2. The method of claim 1 wherein said first selectable region corresponds to an input region.

3. The method of claim 2 wherein said input region comprises a cursor.

4. The method of claim 2 wherein said first selectable region is rectangular.

5. The method of claim 1 wherein said first user gesture in (C) comprises swiping across said first selectable region.

6. The method as in claim 1 wherein each of said one or more second selectable regions is denoted on said screen by an icon or text.

7. The method as in claim 1 wherein each of said one or more second selectable regions has a corresponding action associated therewith, and wherein said method further comprises:
(D) while in said second state, in response to a second user gesture on one of said second selectable regions, said GUI causes said action associated with said one of said second selectable regions to be performed.

8. The method of claim 7 wherein, when said one of said second selectable regions comprises text, and wherein said action associated with said text comprises inserting said text at a location in said first selectable region.

9. The method of claim 5 wherein said swiping across said first selectable region causes said GUI to display said one or more second selectable regions.

10. The method of claim 9 wherein said GUI provides one or more third selectable regions on said screen of said device, said one or more third selectable regions being located on said screen at least partially in said first area of said screen, and
wherein, in a third state of said GUI, at least one of said third selectable regions is active, the method further comprising:
(D) while in said first state, in response to a second user gesture in said first selectable region, exposing at least some of said one or more third selectable regions and causing said GUI to be in said third state.

11. The method of claim 10 wherein said second user gesture comprises swiping across said first selectable region.

12. The method of claim 10 wherein said first user gesture comprises swiping across said first selectable region from right to left, and wherein said second user gesture comprise swiping across said first selectable region from left to right.

13. The method of claim 1 wherein said one or more second selectable regions are located fully within said first area.

14. The method of claim 6 wherein, while in said first state, icons and text associated with said second selectable regions are not visible.

15. The method of claim 15 wherein in said first user gesture makes visible said icons and text associated with said second selectable regions.

16. A computer-implemented method, implemented by hardware in combination with software, the method operable on a device for use in a multimodal communication framework, the method comprising, by a graphical user interface (GUI) on said device, said GUI being implemented by said hardware in combination with said software:
(A) providing a first selectable region on a screen of said device, and at a first area of said screen, said first selectable region being an input region having a cursor associated therewith;
(B) providing one or more second selectable regions on said screen of said device, said one or more second selectable regions being located on said screen in said first area of said screen,
wherein, in a first state, said first selectable region is active and said second selectable regions are inactive and not visible, and
wherein, in a second state, at least one of said second selectable regions is visible and active;
(C) while in said first state, in response to a first user gesture in said first selectable region, exposing at least some of said one or more second selectable regions and causing said GUI to be in said second state, said first user gesture comprising swiping said first selectable region.

17. The method of claim 16 wherein each of said one or more second selectable regions has a corresponding action associated therewith, and wherein said method further comprises:
(D) while in said second state, in response to a second user gesture on one of said second selectable regions, said GUI causes said action associated with said one of said second selectable regions to be performed.

18. A device comprising hardware, including a processor and a memory, the device being programmed to perform the method of claim 1.

19. A tangible non-transitory computer-readable storage medium comprising instructions for execution on a device, wherein the instructions, when executed, perform acts of a method for supporting a graphical user interface (GUI) on said device, wherein the method comprises:
(A) providing, by a graphical user interface (GUI) on said device, said GUI being implemented by said hardware in combination with said software, a first selectable region on a screen of said device, said first region being at a first area of said screen;
(B) said GUI providing one or more second selectable regions on said screen of said device, said one or more second selectable regions being located on said screen at least partially in said first area of said screen,
wherein, in a first state of said GUI, said first selectable region is active and said one or more second selectable regions are inactive, and
wherein, in a second state of said GUI, at least one of said second selectable regions is active;
(C) while in said first state, in response to a first user gesture in said first selectable region, exposing at least some of said one or more second selectable regions and causing said GUI to be in said second state.

20. The tangible non-transitory computer-readable storage medium of claim 19 wherein said first selectable region corresponds to an input region.
